(19) United States
(12) Patent Application Publication
(10) Pub. No.: US 2014/0278875 A1
(43) Pub. Date: Sep. 18, 2014

(54) GROUP BUYING SYSTEMS AND RELATED METHODS

(71) Applicant: United Parcel Service of America, Inc., Atlanta, GA (US)

(72) Inventors: Bala Ganesh, Alpharetta, GA (US); Scott Castaldo, Woodstock, GA (US); Amber Reed, Atlanta, GA (US)

(21) Appl. No.: 14/215,582

(22) Filed: Mar. 17, 2014

Related U.S. Application Data
(60) Provisional application No. 61/792,866, filed on Mar. 15, 2013.

(51) Int. Cl. G06Q 10/08; G06Q 30/06

(52) U.S. Cl. CPC G06Q 10/0836; G06Q 30/0605
USPC 705/14.23; 705/26.2

(57) ABSTRACT

Various embodiments of group buying systems are described. The system enables users to form groups and designate a common delivery/pickup location (e.g., a single home or office), where group members may have their packages delivered. The system also may be configured to suggest that group members make group purchases (e.g., some or all group members by the same or similar items) and may facilitate of aggregation of packages for delivery to the designated common delivery/pickup location.

### CLAIM OF PRIORITY

This application claims the benefit of priority to U.S. Provisional Patent Application No. 61/792,866, filed Mar. 15, 2013, entitled, “Group Buying Systems and Related Methods,” which is incorporated herein by reference in its entirety.

### BACKGROUND

The increase in online retail purchases has led to a significant increase in parcel deliveries to individual homes. While online purchases can be especially convenient for the consumer, the relatively high delivery costs associated with delivering purchased items directly to each customer's home can be significant. A disproportionate percentage of such costs are “last mile” delivery costs, which are the costs associated with delivering goods to their final destination. Such costs are increased when the logistics provider must deliver each individual parcel to a different location, which is common when delivering parcels that include items ordered from online retailers. Various embodiments of the present systems and methods seek to reduce such last mile costs.

### SUMMARY

According to various embodiments, a computer system for aggregating orders for a group of users includes at least one processor and is configured for: 1) receiving a request, from a particular user of a plurality of users to form a group for aggregating orders; 2) at least partially in response to receiving the request, forming the group, wherein the group comprises a plurality of group members including the particular user and at least one other user of the plurality of users; 3) enabling one or more group members to designate a delivery/pickup location, wherein the designated delivery/pickup location is a default delivery/pickup location for one or more orders by the group members; 4) receiving information associated with a first order made by a first group member; 5) at least partially in response to receiving the information associated with the first order made by the first group member, suggesting, to at least a second group member, placing an additional order substantially similar to the first order; 6) receiving: i) notification that the additional order has been placed; and ii) information associated with the additional order; 7) facilitating aggregating the first order and the additional order into a combined shipment; and 8) facilitating delivery of the combined shipment to the designated delivery/pickup location.

### BRIEF DESCRIPTION OF THE DRAWINGS

Reference will now be made to the accompanying drawings, which are not necessarily drawn to scale, and wherein:

FIG. 1 is a block diagram of a Group Buying System according to one embodiment;

FIG. 2 is a block diagram of the Logistics Server of FIG. 1;

FIG. 3 is a flow diagram that generally illustrates various steps executed by the exemplary Group Formation, Buying, and Delivery Module shown in FIG. 2 in accordance with various embodiments of the system of FIG. 1; and

FIG. 4 is an exemplary group delivery package aggregation diagram.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Like numbers refer to like elements throughout.

### System Overview

A computer system, according to various embodiments, allows users to form buying groups. Such buying groups are typically groups of individuals who have common purchasing habits or interests and that are interested in having some or all of their purchases delivered to a common location. In a particular example, if two neighbors are both interested in golf and regularly purchase the same kind of golf ball, the two neighbors may form a buying group and designate one of the neighbors' homes as the buying group's designated delivery location.

Buying group members may place online orders for particular items (e.g., from a particular online retailer) and the system, in various embodiments, sends a message to other members of the buying group (e.g., some members or all members) asking if they would like to purchase the same item and/or a similar item. If so, any other members who wish to make the same or similar purchases complete an order online, submit payment, and indicate that the purchase is associated with a particular group and/or group order. The system then, in a particular embodiment, consolidates the first member's order with the related orders of any other buying group members (e.g., by placing all related orders from the buying group into a single package) and then ships the combined order to the buying group's designated delivery location (e.g., the first member's home or office). After the package is received at the designated delivery/pickup location, the members of the buying group may distribute the ordered items at a convenient time and location (e.g., in the case of golf balls, on the following Saturday at a nearby golf course).

In various embodiments, the system may offer any of a variety of incentives for individuals to form a buying group. For example, the system may offer each member of the group an incentive, discounted shipping, and/or a shipping upgrade on items that are purchased as part of group orders. In addition, or alternatively, the system may offer a price adjustment on the purchased items themselves, or the system may offer loyalty points for such purchases. Moreover, the system may offer each member of the group an incentive to use the designated delivery location as a designated pickup location for the group (e.g., a designated delivery/pickup location).

The system may be associated with any particular entity. For example, the system may be part of an online electronic retail system. Alternatively, the system may be associated with a logistics provider and may be part of a logistics system. Further, the system may be offered by a third party that is neither a retailer nor a logistics provider.

The system may be implemented in many different ways including, for example: via a retail website, a browser plug-in, a social network (e.g., a public social network, a private social network, and/or a business social network), stand-alone software, a mobile application, or any other suitable software/hardware combination. Various embodiments of the system are discussed in greater detail below.

### Exemplary Technical Platforms

As will be appreciated by one skilled in the relevant field, the present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized, including, for example, hard disks, compact disks, DVDs, optical storage devices, and/or magnetic storage devices.

Various embodiments are described below with reference to block diagrams and flowchart illustrations of methods, apparatus (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, smart mobile device, or other programmable data processing apparatus to produce a machine. As such, the instructions which execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Exemplary System Architecture

FIG. 1 shows a block diagram of a Group Buying System 10 according to a particular embodiment of the present invention. As may be understood from this figure, the Group Buying System 10 may include one or more Networks 15, a Logistics Server 25, a Social Network Server 45 (e.g., a sever associated with any service that allows users to make connections and/or to publically or privately share data, pictures, videos, or information), one or more Third Party Servers 35 (e.g., a web hosting server, retailer's server, any other server that hosts websites) and one or more of the following: a Mobile Computing Device 12 (e.g., a handheld computing device, a laptop computer, a smart phone, a tablet computer, or any other mobile computing device) or a Desktop Computer 14.

The one or more Networks 15 facilitate communication between the Mobile Computing Device 12, Desktop Computer 14, Logistics Server 25, one or more Third Party Servers 35, and Social Network Server 45. These one or more Networks 15 may include any of a variety of types of computer networks such as the Internet, a private intranet, a public switch telephone network (PSTN), WAN, LAN, or any other type of suitable network. In certain variations of the embodiment shown in FIG. 1, both the communication link between the Mobile Computing Device 12, Desktop Computer 14, Logistics Server 25, one or more Third Party Servers 35, and Social Network Server 45 are implemented via the Internet using Internet Protocol (IP). The communication link between the Logistics Server 25, one or more Third Party Servers 35, and Social Network Server 45 may be, for example, implemented via a LAN or WAN.

It should be understood that the Servers 25, 35, and 45 do not necessarily need to be deployed over the network. For example, in various embodiments, any or all of the Servers 25, 35, and 45 may be deployed locally on the user's computer, tablet, and/or mobile device.

FIG. 2 shows a block diagram of an exemplary embodiment of an exemplary Logistics Server 25 that is configured for executing a Group Formation, Buying, and Delivery Module 300. It should be understood based on this disclosure that any suitable computer(s) (e.g., any of the computing devices shown in FIG. 1) may be used to execute this module and that various steps executed by the module may be executed on different computers.

The Logistics Server 25 may include several basic computer hardware components. As may be understood from FIG. 2, in this embodiment, the Logistics Server 25 includes a Processor 60 that communicates with other elements within the Logistics Server 25 via a System Interface or Bus 61. The Logistics Server 25 also includes a Display Device/Input Device 64 for receiving and displaying data. This Display Device/Input Device 64 may be, for example, a keyboard, a voice recognition system, or pointing device that is used in combination with a monitor. The Logistics Server 25 further includes a Memory 66, which preferably includes both a Read Only Memory (ROM) 65 and a Random Access Memory (RAM) 67. The server's ROM 65 may be used to store a Basic Input/Output System (BIOS) 26 that contains the basic routines that help to transfer information between elements within the Logistics Server 25.

Also located within the Logistics Server 25 is a Network Interface 74 for interfacing and communicating with other elements of a computer network. It will be appreciated by one of ordinary skill in the art that one or more components of the Logistics Server 25 may be located geographically remote from other components of the Logistics Server 25 and/or that certain components may be omitted from particular embodiments. Furthermore, one or more of the components may be combined, and additional components performing functions described herein may be included in the Logistics Server 25.

The Logistics Server 25 may also include at least one Storage Device 63, such as a hard disk drive, a floppy disk drive, a CD Rom drive, or an optical disk drive, for storing information on various computer-readable media, such as a hard disk, a removable magnetic disk, or a CD-ROM disk. As will be appreciated by one of ordinary skill in the art, each of these Storage Devices 63 may be connected to the Bus 61 by an appropriate interface. The Storage Devices 63 and their associated computer-readable media may provide nonvolatile storage for the Logistics Server 25. It should be noted that the computer-readable media described above could be replaced by any other type of computer-readable media known in the art. Such media includes, for example, magnetic cassettes, flash memory cards, and digital video disks.

A number of program modules may be stored by the various storage devices and/or within the RAM 67. Such program modules include an Operating System 80 and a Group Formation, Buying, and Delivery Module 300. For simplicity and brevity, these modules are merely exemplary and may represent a number of program modules which control certain aspects of the operation of the Logistics Server 25 with the assistance of the Processor 60 and the Operating System 80. Exemplary embodiments of the Group Formation, Buying, and Delivery Module 300 are described in more detail below.

### Exemplary Group Buying Module

A particular embodiment of the Group Formation, Buying, and Delivery Module 300 is shown in FIG. 3. As noted above, any suitable computing device, such as any of the Servers 25, 35, 45 shown in FIG. 1 may alone, or in combination, perform the method steps of FIG. 3. In various embodiments, all of the steps of FIG. 3 are performed by the exemplary Logistics Server 25 shown in FIG. 2. However, it should be understood in light of this disclosure that the module may be executed by any other suitable computer (such as any of the computers shown in FIG. 1) and that other exemplary embodiments may be created by adding other steps or by removing one or more of the method steps shown in FIG. 3.

Creating a Buying Group

Beginning at Step 302, the Group Formation, Buying, and Delivery Module 300 receives a request, from a particular user from a plurality of users, to form a buying group. The particular user may be, for example, a customer of an online retail website, a member of a logistics service (e.g., UPS MyChoice®), a member of a social network (e.g., Facebook®), and/or a member of any other service that enables users to make connections and/or form groups. In a particular embodiment, the user is a customer of a logistics service, and the customer issues a request to the system to create a buying group that includes the user and one of the user's neighbors who is also a member of the logistics service.

In some embodiments, the system may provide the user with the option to invite those who are not members of the logistics service (or other service) to join the service so that they may join the buying group.

At Step 304, at least partially based on receiving the request, the system forms the buying group that includes the particular user and at least one other user. In various embodiments, the system is configured to form the group by saving information corresponding to each member of the group to a database associated with the system. In a particular embodiment, the system is configured to associate this listing of group members with a particular name for the group. According to one or more embodiments, the particular user may provide the name for the group so that the user may easily identify the group in the future.

In various embodiments, the system is configured to associate a unique group buying identifier with the buying group. The system may be configured to associate the unique group buying identifier with the buying group in any suitable way. In various embodiments, the system is configured to associate the unique group buying identifier with the buying group by associating the unique group buying identifier with each group member in a database. In a particular embodiment, the system is configured to associate the unique group buying identifier with the buying group by associating the unique group buying identifier with a unique password, which may be, for example, transmitted to the buying group members to be used when making a purchase.

The unique group buying identifier may be in any suitable form. In a particular embodiment, the group buying identifier is a string of alphanumeric characters. In various embodiments, the group buying identifier comprises a symbol, a series of symbols, a password, a barcode, and/or a digital certificate.

At Step 306, the system enables one or more group members to designate a common delivery/pickup location for the group. In various embodiments, any group member may designate the designated delivery/pickup location. However, in certain embodiments, the system is adapted to request this information from a user before setting up the group (e.g., forming the group).

It should be understood, in light of this disclosure, that any of various methods may be used to designate a designated delivery/pickup location for a particular buying group. In certain embodiments, the system may have the founder of the group establish a set delivery/pickup location that is used for all of the buying group's deliveries. In other embodiments, the system may suggest or automatically establish a designated delivery/pickup location based on information associated with the buying group's various members. In certain embodiments, one or more members of the buying group may designate the designated delivery/pickup location with each delivery.

In some embodiments, the designated delivery/pickup location may be populated from or to a group member's online address book. In this embodiment, the group member chooses the designated delivery/pickup location from the address book when choosing shipping options for the purchase. This may allow the system to automatically change the address of the designated delivery/pickup location when the address changes within the group member's online address book. For example, if the designated delivery/pickup location is a particular buying group member's home address, and that group member changes their residential address, the designated delivery/pickup location would change automatically when the group member updates their home address in their online address book.

In various embodiments, the system may be configured to allow one or more group members to designate an alternate delivery/pickup location. In particular embodiments, the system may be adapted to coordinate delivery to the alternate delivery/pickup location if the group's primary delivery/pickup location is unavailable and/or if one or more group members indicate (e.g., using the system) that the alternate delivery/pickup location is the preferred delivery/pickup location for a particular group order. In particular embodiments, each group may designate a plurality (e.g., up to four or more) alternate delivery/pickup locations.

In particular embodiments, the designated delivery/pickup location may be a group member's residence. In other embodiments, the designated delivery/pickup location may be a group member's office. In one or more embodiments, the designated delivery/pickup location is an attended delivery/pickup location (e.g., a business that accepts parcels for a group member, such as a store with lockers for parcel storage, a business that receives the one or more parcels for a group member and stores the one or more parcels for the group member's pickup, etc.). In further embodiments, the designated delivery/pickup location is a virtual address for a group member (e.g., an address that represents one or more addresses for the group member (e.g., the group member is at address A Monday through Friday and address B on Saturday and Sunday) or an address that represents a location of the group member (e.g., the group member's current geolocation and/or the geolocation of the group member's vehicle)). In still further embodiments, the designated delivery/pickup location may be a location central to all group members such as a subdivision office building, a neighborhood meeting place, a school, a local coffee shop, or any other suitable delivery/pickup location.

Receiving Information, Notifications, and Orders

At Step 308, the system receives notification that a first member of the buying group has placed a first order. The system may be configured to receive notification of a first order in one or more suitable ways. In various embodiments, the system is configured to receive notification of the first order directly from a retail website where the first order was placed. In other embodiments, the system is configured to receive the notification via a user-installed browser add-on or plug-in. In further embodiments, the system is configured to receive notification of the first order via a web service that searches the data associated with a user's email for purchase confirmation emails (e.g., “scrapes” the user's email). In further embodiments, the system is configured to receive the notification of the first order via a social network or other web service that is capable of tracking user orders (e.g., from the one or more Third Party Servers 35).

According to various embodiments, the system is configured to provide an intermediate graphical user interface (“intermediate GUI”) that acts as an interface between a website associated with a retailer and the members of a buying group. In particular embodiments, the intermediate GUI provides an interface for members of the buying group that appears and functions in a way that mimics and/or replicates the functionality of a retail website. In such embodiments, the system may be configured to use the data of the online retailer (received, for example, via a suitable application programming interface (“API”) to populate the intermediate GUI with data.

In particular embodiments, the intermediate GUI receives orders (e.g., which items and what quantity of items the group members wish to purchase from the online retailer), payment information (e.g., credit card information for each group member, how much the group member has authorized to be spent on the items to be purchased from the online retailer, etc.), shipping information, and other purchase details from the members of the buying group (including, for example, the first member of the buying group) wishing to make a purchase from the online retailer. In various embodiments, the intermediate GUI collects the orders of the buying group members who wish to make a purchase from the online retailer and then, for example, submits a combined order to the online retailer. The order may be an aggregate of all of the orders of all of the buying group members who wish to make a purchase from the online retailer. In various embodiments, the order may include a single payment for all items within the group members' various orders.

In a particular example, a first group member accesses the intermediate GUI provided by the system (e.g., logs in with an account number and password). The first group member, in various embodiments, indicates they wish to shop on a retail website called Retail.com. Continuing with this example, the first group member is provided with an interface that includes data from Retail.com that was received from a suitable API. The first group member, in this example, chooses to purchase a single can of tennis balls and completes a check-out process on the intermediate GUI (e.g., the first group member chooses the can of tennis balls, submits credit card information, submits shipping information, etc. and completes the order). In a particular embodiment, the intermediate GUI collects the first group member's purchasing information and sends a notification to one or more other group members suggesting that other group members (e.g., at least one other group member) also purchase tennis balls (e.g., the same brand, etc.).

Continuing with this example, a second group member logs into the intermediate GUI and purchases tennis balls as suggested by the system (e.g., the first group member and the second group member make a group purchase of tennis balls). The second group member selects two cans of tennis balls and completes the check-out process, for example, in substantially the same way as the first group member and completes the check-out process as described for the first group member above. After receiving the second order (and/or orders from additional group members), in this example, the intermediate GUI submits a single order for three cans of tennis balls representing the first group member and the second group member's respective purchases with a single payment.

In particular embodiments, an intermediary (e.g., a logistics company or other company) receives and processes payment for the items directly from the customers, and then coordinates payment for the consolidated order directly with the retailer. The intermediary may coordinate the payment for the consolidated order in any suitable way, including: 1) PayPal (other another suitable electronic payment service); 2) cash; 3) credit card; and/or 4) the intermediary may use a line of credit for the customers (e.g., the users have an account with the intermediary and pay the intermediary for group purchases or other purchases after the purchases are made).

At Step 310, the system suggests, to at least a second group member, placing an additional order that is substantially similar to the first order. The system may be configured to suggest placing an additional order to any number of group members. In some embodiments, the system is configured to suggest to only one other group member to make an additional purchase. In other embodiments, the system is configured to suggest to a subset of the group members based on social network, geographic location, and/or other data. In further embodiments, the system is configured to suggest to all group members to place the additional order.

In various embodiments, the system may allow a user to hand-pick users from their buying group to participate in group buys. For example, a first user may form a buying group and purchase an item. The first user, in this particular example, may then indicate which particular group members may be interested in the item or similar items. These selected buying group members may collectively be a subset of all members in the buying group. At least partially in response to the first user indicating interested buying group members, the system may send a notice to the indicated buying group members. In some embodiments, the first user may also post a notice that the item was ordered with a link or discount code to allow other (e.g., non-selected) group members to order the item.

The system may suggest various types of orders. In some embodiments, the system is configured to suggest placing an order for the same item. In various embodiments, the system may be configured to suggest different items (e.g., items different from the item purchased by the first user) to members of the buying group from the same or a different retailer in response to the first user purchasing the item. The suggestions may be at least partially based on data collected by the system. In a particular example, User A, User B, and User C are part of a buying group. User A purchases a coffee pot. In response to User A purchasing the coffee pot, the system may suggest to User B that they purchase a hard drive from the same retailer (which may result in a price adjustment on the purchase due to the group purchase if the purchase is made by an established deadline). Additionally, the system may suggest to User C that they purchase a toaster from a different retailer by the deadline. To entice Users A, B, and C to buy together, the system may offer a price adjustment on shipping to a single delivery/pickup location and/or a price adjustment on some of the items (e.g., those from the same retailer) or all of the items (e.g., even from different retailers), or any other combination of price adjustments or other incentives.

In particular embodiments, the system may be configured to suggest that the second group member place an order for an item that varies slightly from the first order. For example, the system may suggest that the second group member purchase an item that is considered to be an accessory to the item(s) of the first order.

In various embodiments, the system may be configured to offer group incentives, discounted shipping, or special shipping options to entice group members to place the additional order. In particular embodiments, the system is configured to entice the second member to place the order by offering a price adjustment or one or more other incentives (e.g., a discounted sales price and/or discounted shipping) to the first and second group members (e.g., if at least the second member orders the same or similar item by a specified deadline). If the system is implemented by an entity other than a particular retailer, the entity may work in conjunction with the retailer to coordinate execution of the price adjustment on the retailer's website, or the price adjustment may be implemented in any other suitable manner.

In some embodiments, the group incentive notification may be associated with a social network. In particular embodiments, the system may be configured to facilitate posting the group incentive notification on a social network. For example, the group price adjustment may be displayed on a social network's designated notification location or electronic bulletin board (e.g., a group member's Wall® on Facebook®).

In various embodiments, there is a limitation on the group price adjustment. In some embodiments, the group price adjustment may only be valid if at least a predetermined number of group members place an additional order. In various embodiments, the group price adjustment may expire after a predetermined amount of time. For example, the group price adjustment may be an offer to apply a predetermined price adjustment (e.g., 5%) to the group's collective order if ten group members place an order for one or more items within 24 hours of an initial order placed by a member of the group.

At Step 312, the system receives notification that the second group member has ordered the same or similar item by the specified deadline (e.g., in time for both orders to be combined into a single shipment). The system may be configured to receive notification of this at least one additional order in any of the ways (or other ways) the system may have received the notification of the first order.

Aggregation and Delivery of Orders

At Step 314, the system, at least partially in response to receiving notification of the at least one additional order, facilitates aggregating the first order and the at least one additional order into a combined order. In various embodiments, when the orders are from the same retailer, the system may be configured to facilitate aggregating the orders by scheduling the shipment of the orders to be at substantially the same time. In other embodiments, the orders are from different retailers. In these embodiments, the system may be configured to facilitate aggregating the orders at distribution facility or other location.

The combined order may be any suitable arrangement of one or more parcels associated with the first order and the additional order. In various embodiments, the first order and the additional order may each include one or more items. In particular embodiments, the system is configured to facilitate aggregating the first order and the additional order by facilitating aggregating the one or more items of the first order and the one or more items of the additional order into the same parcel for delivery. In some embodiments, the system is configured to facilitate aggregating the first order and the additional order by facilitating shipping one or more parcels associated with the first order and one or more parcels associated with the additional order at substantially the same time to the designated delivery/pickup location.

At Step 316, the system facilitates delivery of the combined shipment to the buying group's designated delivery/pickup location.

### Exemplary Group Buying Package Aggregation

FIG. 4 is an exemplary group delivery package aggregation diagram. The elements of FIG. 4 visually depict how the Group Formation, Buying, and Delivery Module 300 may function in one embodiment. Solid lines denote parcel delivery by a logistic company and dashed lines denote delivery by a user. In this example, there are three Users: User 1, User 2, and User 3 (collectively “Users”). The Users have two common characteristics. First, Users 1, 2, and 3 live in the same neighborhood. Second, the Users are connected to each other on an online social network (e.g., they are Facebook® “friends”).

To begin, at FIG. 4, the system receives a request from User 1 to form a Buying Group that includes Users 1, 2 and 3. (e.g., Step 302 in FIG. 3). In response to receiving the request, the system forms the group (e.g., on Facebook®) and enables Users 1-3 to designate a common delivery/pickup location for the buying group's deliveries (e.g., Steps 304 and 306 in FIG. 3).

The Users designate User 3's Office 440 as a common delivery/pickup location for the group. User 3 has a secretary at his office who signs for all packages, which makes accepting deliveries at this location very convenient. User 3 then offers to deliver User 1 and User 2's parcels to User 3's Residence 423, where User 1 and User 2 can pick up their parcels.

User 1 places an order for tennis balls from an online retailer that uses a particular distribution facility to facilitate distribution of its tennis balls. In response to User 1 placing the order, the system suggests that Users 2 and 3 also buy tennis balls from the same online retailer. The system additionally offers the Users 1-3 a 5% price adjustment on their tennis ball purchase if they collectively order at least 10 cans of tennis balls by a particular deadline and have all of the tennis balls delivered, as part of a single shipment, to the designated delivery/pickup location (e.g., User 3's Office 440). Users 1-3 collectively order ten cans of tennis balls (with each user separately placing and paying for their separate order), by the established deadline.

Continuing with FIG. 4, the system facilitates aggregation of the individual orders into a single Combined Parcel 450 (e.g., all ten cans of tennis balls are placed into a single parcel for shipment). A logistics company then delivers the Combined Parcel 450 to User 3's Office 440 where User 3's secretary signs for the parcel. At the end of the workday, User 3 takes the Combined Parcel 450 to User 3's Residence 423 within the neighborhood that User 3 shares with User 1 and User 2. Users 1 and 2 then pick up their orders, at their leisure, and bring the orders to their residences, 421 and 422.

As an alternative, rather than combining the orders into a single Combined Parcel 450, each order may be placed into its own respective parcel, and the system may facilitate delivery of the various individual parcels together to the designated delivery/pickup location (e.g., User 3's Office 440). For purposes of this disclosure, it should be understood that aggregating two or more orders into a combined shipment may involve either placing the orders into a single parcel, or otherwise coordinating delivery of the orders to a common location at substantially the same time.

### Exemplary Contexts for Implementation

In particular embodiments, the above systems and methods may be implemented, for example, by: (1) an online retailer; (2) one or more logistics providers (e.g., a common carrier); (3) a combination of an online retailer and a logistics provider. However, it should be understood that such systems and methods may be implemented in any other suitable context.

### CONCLUSION

Many modifications and other embodiments of the present systems and methods will come to mind to one skilled in the art having the benefit of the teachings presented in the foregoing descriptions and associated drawings. Therefore, it is to be understood that the present systems and methods are not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer system for aggregating orders for a group of users comprising:
at least one processor, wherein the computer system is configured for:
(A) receiving a request, from a particular user of a plurality of users to form a group for aggregating orders;
(B) at least partially in response to receiving the request, forming the group, wherein the group comprises a plurality of group members including the particular user and at least one other user of the plurality of users;
(C) enabling one or more group members to designate a delivery/pickup location, wherein the designated delivery/pickup location is a default delivery/pickup location for one or more orders by the group members;
(D) receiving information associated with a first order made by a first group member;
(E) at least partially in response to receiving the information associated with the first order made by the first group member, suggesting, to at least a second group member, placing an additional order substantially similar to the first order;
(F) receiving:
notification that the additional order has been placed; and
information associated with the additional order;
(G) facilitating aggregating the first order and the additional order into a combined shipment; and
(H) facilitating delivery of the combined shipment to the designated delivery/pickup location.

2. The computer system of claim 1, wherein the computer system is configured for receiving the information associated with the first purchase made by the first group member and the information associated with the additional order via an intermediate graphical user interface.

3. The computer system of claim 2, wherein:
(A) the first order by the first group member is made via the intermediate graphical user interface; and
(B) the intermediate graphical user interface is adapted to substantially appear and function like a website of a particular retailer.

4. The computer system of claim 3, wherein the intermediate graphical user interface is adapted to substantially appear and function like the website of the particular retailer by using data associated with a suitable application programming interface associated with the particular retailer.

5. The computer system of claim 2, wherein:
(A) the intermediate graphical user interface is configured for receiving orders from the group members; and
(B) the first order and the additional order each comprise payment information associated with the first order and the at least the additional order, respectively.

6. The computer system of claim 5, wherein:
(A) the first order and the additional order are each from a particular online retailer; and
(B) the intermediate graphical user interface is configured for:
(i) aggregating the first order and the additional order; and
(ii) submitting the aggregated first and additional order to the particular online retailer.

7. The computer system of claim 6, wherein the payment information comprises a form of payment selected from the group consisting of:
(A) an electronic payment service; and
(B) a credit card.

8. The computer system of claim 1, wherein the first order is from a non-online retailer.

9. The computer system of claim 1, wherein the computer system is configured for:
(A) receiving the information associated with the first purchase made by the first group member via an intermediate graphical user interface; and
(B) receiving the information associated with the additional order via a browser add-on.

10. The system of claim 1, wherein the designated delivery/pickup location further comprises selecting one or more alternate delivery/pickup locations.

11. The system of claim 1, wherein the designated delivery/pickup location is a location selected from the group consisting of:
(A) a residence;
(B) a virtual address;
(C) an attended delivery/pickup location; and
(D) a location comprising one or more user-accessible lockers.

12. The system of claim 1, wherein suggesting placing the additional order comprises sending a notification with one or more details of a group incentive for a minimum number of orders.

13. The computer system of claim 1, wherein the collected data comprises data selected from a group consisting of:
(A) social network data;
(B) purchase history data; and
(C) geographical data.

14. The system of claim 12, wherein the group incentive comprises a reduction in the price of the first order and the additional order.

15. The system of claim 12, wherein sending the notification with details of the group incentive further comprises sending a notification associated with the social network.

16. The system of claim 12, wherein the group incentive expires after a predetermined amount of time.

17. The computer system of claim 1, wherein forming the group comprises associating a particular group buying identifier with the group members.

18. The computer system of claim 17, wherein receiving notification that the first group member has placed the first order comprises receiving the particular group buying identifier and the first order.

19. The computer system of claim 18, wherein receiving notification of the additional order comprises receiving the particular group buying identifier and the additional order.

20. The computer system of claim 1, wherein:
(A) the first order comprises one or more first items; and
(B) the additional order comprises one or more additional items.

21. The computer system of claim 20, wherein the combined shipment comprises the one or more first items and the one or more additional items in a single parcel.

22. The computer system of claim 20, wherein the combined shipment comprises:
(A) the one or more first items in a first parcel; and
(B) the one or more additional items in a second parcel.

23. A computer system for aggregating orders for a group of users comprising:
at least one processor, wherein the computer system is configured for:
(A) receiving a request, from a particular user of a plurality of users connected on a social network, to form a group for aggregating orders;
(B) at least partially based on receiving the request, forming the group, wherein the group comprises members including the particular user and at least one other user of the plurality of users;
(C) enabling one or more group members to designate a delivery/pickup location for the delivery of one or more orders by the group members, wherein the designated delivery/pickup location is a default delivery/pickup location for the one or more orders by the group members;
(D) receiving notification that a first group member is placing a first order with a online retailer, wherein the first order comprises payment information associated with the first group member;
(E) collecting the first order before the first order is submitted to the online retailer;
(F) at least partially in response to collecting the first order, suggesting, to one or more other group members, placing an additional order substantially similar to the first order;
(G) receiving notification that the one or more other group members is placing the additional order with the online retailer, wherein the additional order comprises payment information associated with the one or more other group members;
(H) collecting the additional order before the additional order is submitted to the online retailer;
(I) submitting the first order and the additional order to the online retailer; and
(J) facilitating delivery of the first order and the additional order to the designated delivery/pickup location.

24. The computer system of claim 23, wherein the payment information associated with the first group member comprises credit card information associated with the first group member.

25. The computer system of claim 23, wherein the first order and the additional order are submitted at substantially the same time to the online retailer.

26. The computer system of claim 23, wherein submitting the first order and the additional order to the online retailer comprises submitting a single payment for the first order and the additional order.

27. The computer system of claim 23, wherein forming the group comprises associating a particular group buying identifier with the group members.

28. The computer system of claim 27, wherein receiving notification that the first group member is placing the first order with the online retailer comprises receiving the particular group buying identifier and the first order.

29. The computer system of claim 28, wherein receiving notification that the one or more other group members is placing the additional order with the online retailer comprises receiving the particular group buying identifier and the additional order.

30. A computer system for aggregating orders for a group of users comprising:
at least one processor, wherein the computer system is configured for:
(A) receiving a request from a particular user of a plurality of users to form a group for aggregating purchases;
(B) at least partially based on receiving the request, forming the group, wherein:
the group comprises group members including the particular user and at least one other user of the plurality of users; and
forming the group comprises assigning a group buying identification number to the group members;
(C) enabling one or more group members to designate a delivery/pickup location for the delivery of one or more purchases by the group members, wherein the designated delivery/pickup location is a default delivery/pickup location for the delivery of the one or more purchases by the group members;
(D) receiving information associated with a first purchase made by a first group member on a particular website associated with a particular retailer, wherein the first purchase comprises one or more first items;
(E) at least partially in response to receiving the information associated with the first purchase made by the first group member, suggesting making an additional purchase with the particular retailer to at least a second group member, wherein:
suggesting, to at least the second group member making the additional purchase comprises offering the second group member a price adjustment on the additional purchase; and
the additional purchase comprises one or more additional items;
(F) receiving notification of the additional purchase made by the second group member and information associated with the additional purchase;
(G) facilitating aggregation of the first purchase and the additional purchase into a single delivery, wherein aggregating the first purchase and the additional purchase into a single delivery comprises scheduling delivery of the one or more first items and the one or more additional items at substantially the same time; and
(H) facilitating delivery of the single delivery to the designated delivery/pickup location.

31. The computer system of claim 30, wherein the group members are members of a social network.

32. The computer system of claim 31, wherein the social network comprises a public social network.

33. The computer system of claim 32, wherein group is formed on the public social network.

34. The computer system of claim 31, wherein the social network comprises a private social network.

35. The computer system of claim 34, wherein the private social network is associated with a logistics company.
